(19) United States
(12) Patent Application Publication
(10) Pub. No.: US 2021/0079268 A1
(43) Pub. Date: Mar. 18, 2021

(54) ADHESIVE TAPE

(71) Applicant: CERTOPLAST TECHNISCHE KLEBEBÄNDER GMBH, Wuppertal (DE)

(72) Inventors: Timo LEERMANN, Wuppertal (DE); Rene RAMBUSCH, Wuppertal (DE)

(21) Appl. No.: 16/966,977

(22) PCT Filed: Feb. 25, 2019
(86) PCT No.: PCT/EP2019/054614

§ 371 Date: Aug. 3, 2020

(30) Foreign Application Priority Data
Mar. 2, 2018 (DE) 20 2018 101 168.5

(51) Int. Cl. C09J 7/29; C09J 7/21; D03D 11/00; D03D 15/00; D03D 15/02

(52) U.S. Cl. CPC C09J 7/29; B32B 2405/00; D03D 11/00; D03D 15/0011; D03D 15/02; C09J 2203/302; C09J 2400/143; C09J 2400/163; C09J 2400/263; C09J 2467/006; C09J 2477/006; D10B 2101/06; D10B 2101/12; D10B 2101/20; D10B 2331/02; D10B 2331/04; D10B 2505/12; C09J 7/21

(57) ABSTRACT

The invention relates to an adhesive strip, in particular a winding strip for sheathing cables in automobiles, comprising a textile support (1.2) that has at least one first fabric (1) and a second fabric (2) which are connected together and comprising an adhesive coating (5) on at least one face of the support (1, 2). According to the invention, the two fabrics (1, 2) are preferably coupled together solely by connection threads (3) of the fabrics.

The invention relates to an adhesive tape, in particular a tape for wrapping cables in automobiles, comprising a textile substrate formed by at least one first textile web and a second textile web that are connected together and an adhesive coating on at least one face of the substrate.

Various requirements are required in adhesive tapes and in particular wrapping tapes for wrapping cables in automobiles. Thus it is important not only, for example, to have a necessary media resistance to, for example, oil, gasoline or diesel, but also temperature resistance over a wide temperature range from minus 50° C. or minus 40° C. to plus 150° C. and more is required. Moreover, such adhesive tapes must be resistant to aging.

In addition, nowadays enhanced requirements relating to abrasion resistance apply. This results inter alia because motor vehicles are increasingly being equipped with electrical components and associated connecting cable harnesses. Since the installation space is limited, chafing of the cables can occur. This is counteracted by an increased abrasion resistance of the adhesive tapes or wrapping tapes for wrapping the cables.

In the prior art a generic adhesive tape that should be designed to be abrasion-resistant overall is described in WO 2005/085379 [U.S. Pat. No. 8,815,389]. This is achieved in particular by coupling a PET filament fabric as a first textile web to a second textile web likewise designed as a PET filament fabric via an intermediate layer. The intermediate layer may be an adhesive layer or also a porous sheet material with an open, but stable three-dimensional structure made of a foam material or a foamed film. However, manufacture of such a laminated textile web from the at least two textile webs or fabric layers is complicated.

Other approaches in the prior art for increasing not only the abrasion resistance, but also in general for controlling particular mechanical stresses due to accidents, vibrations, chafing, piercing, cutting and abrading, are directed to a protective device, as described in WO 2009/086570. The protective device consists of at least one composite comprising a mechanical protective coating containing inorganic fibers, a polymeric connecting layer directly connected to the coating and having an insulating effect, and an adhesive layer directly connected to the coating. In this case also manufacture is particularly complicated.

In addition to the already described abrasion resistance, nowadays in the case of adhesive tapes or, generally, protective wrappings for cables, it is increasingly important to control stresses caused in particular by accidents, i.e. impact stresses. In essence, these increasing requirements can be attributed to the fact that increasingly in the case of electric vehicles, but also in conventional motor vehicles, security-related components such as, for example, door locks are predominantly electrically operated or an exclusively electrical operation is desired. In the event of a crash and, for example, in the event of a lateral impact, this can lead to problems in such a way that electrical leads for voltage supply, for example, to the door locks are torn, damaged or their functional capability is impaired in some other way. This can then lead to the door lock in question no longer functioning, so that an associated motor vehicle door cannot be opened or can be opened only with difficulty by rescue personnel. The previous solutions in particular according to WO 2005/0853791 or also WO 2009/086570 are not very convincing on this point or can only be implemented at increased cost. The invention seeks to create a remedy here.

The object of the invention is to further develop such an adhesive tape, and in particular a tape for wrapping cables in automobiles so that, in the event of unchanged high abrasion resistance, in particular mechanical stresses during a crash can be managed with reduced manufacturing costs by comparison with the prior art.

In order to attain this object the invention proposes that, in a generic adhesive tape and in particular a tape for wrapping automobiles in motor vehicles, the two textile webs are preferably connected to one another exclusively by connection filaments of the textile webs.

Thus, the invention first of all uses a specially assembled textile substrate, which is ultimately assembled as a laminate from at least the first textile web and the second textile web. In fact, reference may also be made to an at least two-layered substrate assembled from the two textile webs or fabric layers. Thus, the term “laminate” does not necessarily imply adhesion of both layers, although such adhesion is possible in principle as a supplement to the connection filaments of the textile webs. The textile substrate is usually assembled according to the invention and definitively from the first and second textile web that define the two-layered substrate and are connected to one another without adhesive by the connection filaments.

Of course, more than two fabric layers can be used, for example a third textile web and also a fourth textile web, if necessary. Usually, however, two fabric layers consisting of the first textile web and the second textile web are sufficient in order to provide the necessary abrasion resistance as well as an increased impact strength and therefore resistance to mechanical stress in particular in the event of an accident.

Within the context of the invention these two textile webs or fabric layers, in contrast to the prior art for example according to WO 2005/085379, are not coupled together by an adhesive layer or a porous sheet material made of a foam material or a foamed film. In fact, at this point the invention relies on connection filaments of the textile webs that couple the two textile webs or fabric layers mechanically to one another. Consequently, the connection filaments of the textile webs are warp and/or weft filaments of the first textile web, of the second textile web or also of both textile webs.

In this way the textile substrate for the adhesive tape used according to the invention can be made particularly simply and cost-effectively, that is to say ultimately during a (modified) weaving process. Consequently, additional coatings and the initially separate production of the fabric layers as well as their subsequent connection are generally unnecessary. In principle, within the scope of the invention the first textile web and the second textile web can be coupled to one another not only by the connection filaments of the textile webs for the mechanical coupling but also by an additionally provided connection layer of, for example, an adhesive medium. As a rule, however, solely the connection filaments ensure that the two textile webs or fabric layers are mechanically coupled to one another. Then it is advantageously possible to rely on a single weaving process without additional lamination operations.

A further special feature the invention proposes that the two textile webs or fabric layers each have the same weave. In fact, the invention recommends in principle reliance on the basic weaves known from the weaving industry, that is to say the plain weave, twill weave or also atlas weave for the respective textile web. In other words, both textile webs can be provided, for example, with a plain weave.

However, according to a particularly advantageous embodiment it has proved worthwhile if the two textile webs are of different weaves. For example, the first textile web or the first fabric layer may have a plain weave. On the other hand, the second fabric layer below the first, or the second textile web can be provided with an atlas weave or specifically a satin weave. In this way the substrate and therefore the entire adhesive tape can be made mechanically particularly stable, in particular with regard to any impact stress.

In this case the invention makes use of the recognition that the canvas formation that is mostly placed outside during wrapping of cables is “opened” during impact stress in the region of the acting force. Since the second textile web or the atlas weave or satin weave below it in the impact direction is structured differently, this shows another opening behavior in the event of the described impact stress, so that overall the stability relative to such impact stresses can be significantly increased without additional measures.

In fact, the first fabric layer or the first textile web in plain weave typically directed outwards during wrapping of cables is characterized in that the respective weft filament passes through alternately over and under the individual warp filaments. As a result both faces of the first textile web look the same. On the other hand, the second textile web or the second fabric layer located below the first is advantageously provided with an atlas weave or satin weave. Here the respective weft filaments are guided through below a warp filament and then guided along over more than two warp filaments. The next weft filament shifts this weave pattern by at least two warp filaments usually toward the right and also upward, usually by one. The second textile web or second fabric layer with the atlas weave or satin weave that is made in this way is a textile web in which the parallel weft filaments substantially predominate on the upper face, that is to say in the direction of the first textile web. On the other hand, on the rear face the warp filaments correspondingly predominate.

One way or another, the result of the sequence plain weave-atlas weave or also plain weave-twill weave is generally that a textile web assembled with two layers in this way, in the event of impact stress, initially opens the first textile web in the plain weave and then a different opening is observed in the second textile web having the atlas weave or twill weave and is located below the first textile web. As a result of these different opening processes in conjunction with the coupling together of the two textile webs by the connection filaments, impact stresses, as observed for example in the event of an accident, are particularly effectively controlled and absorbed.

Furthermore, since the filaments of the respective textile web are polyester or also polyamide filaments and additionally, if required, inorganic filaments such as metal filaments, carbon filaments or also glass filaments as well as overall combinations in the weaving process can be taken into consideration, an increased abrasion resistance is observed. In other words, the adhesive tape according to the invention for the first time not only fulfills the typical requirements for automobiles such as media resistance, temperature resistance and rattle suppression but also increased abrasion resistance and significantly increased impact strength by comparison with previous prior art, as can be measured, for example, according to the standard LV 312-3. This was not expected and also not possible in the past.

The textile substrate usually has a basis weight of 100 g/m² to 250 g/m² and preferably up to 500 g/m². For the filaments of the respective textile web a fineness of at least 100 dtex is recommended. The filaments of the textile web usually have a fineness of more than 150 dtex. In this case it has additionally proved particularly favorable if filaments of different fineness are used.

For example, if required, it is possible to use weft filaments that are thicker than the warp filaments. Usually, however, the warp and weft filaments of both textile webs have the same fineness. This then also applies to the connection filaments. In fact, the connection filaments can be formed as warp and/or weft filaments of the first textile web or also of the second textile web. However, in principle it is also possible that the connection filaments are warp and/or weft filaments of both the first textile web and also of the second textile web.

In this case, in detail, the procedure can be such that the connection filaments are weft filaments of the first textile web that cross one or more warp filaments of the second textile web. In principle, however, the connection filaments can also be formed as warp filaments of the first textile web that cross one or more weft filaments of the second textile web. Furthermore, the connection filaments can be weft filaments of the second textile web that cross one or more warp filaments of the first textile web. Likewise, it is conceivable that the connection filaments are warp filaments of the second textile web that cross one or more weft filaments of the first textile web. In addition, mixed forms are also conceivable in principle.

The adhesive or the adhesive coating used is one that is applied over the entire surface or as a strip coating, advantageously on the rear face of the second textile web. Furthermore, it is within the scope of the invention to provide the outwardly directed first textile web with an additional coating, for example an elastomer coating, a lacquer film or lacquer layer, if this is necessary. Furthermore, the individual filaments of the textile web can be colored, if required, and also different colors are possible for the first textile web and the second textile web, in order to increase the number of conceivable color combinations.

The adhesive coating overall can be applied to the textile substrate with a basis weight of 50 g/m² to 200 g/m². Adhesives that have proven particularly favorable as possible and suitable adhesives are, in particular, pressure-sensitive adhesives such as acrylate adhesives. These can be applied to the textile substrate, for example, by direct coating, contact coating or also as melt coating with subsequent UV cross-linking. Indirect coating during a transfer coating is also possible in principle.

The adhesive tape according to the invention can be formed in principle as a wrapping tape guided spirally or helically around cables. Alternatively, a longitudinal wrapping can also be implemented with the aid of the adhesive tape. In this case the adhesive tape is closed in a longitudinal direction around the cable to be wrapped.

The invention is explained in greater detail below with reference to drawings that show only one embodiment, and in which:

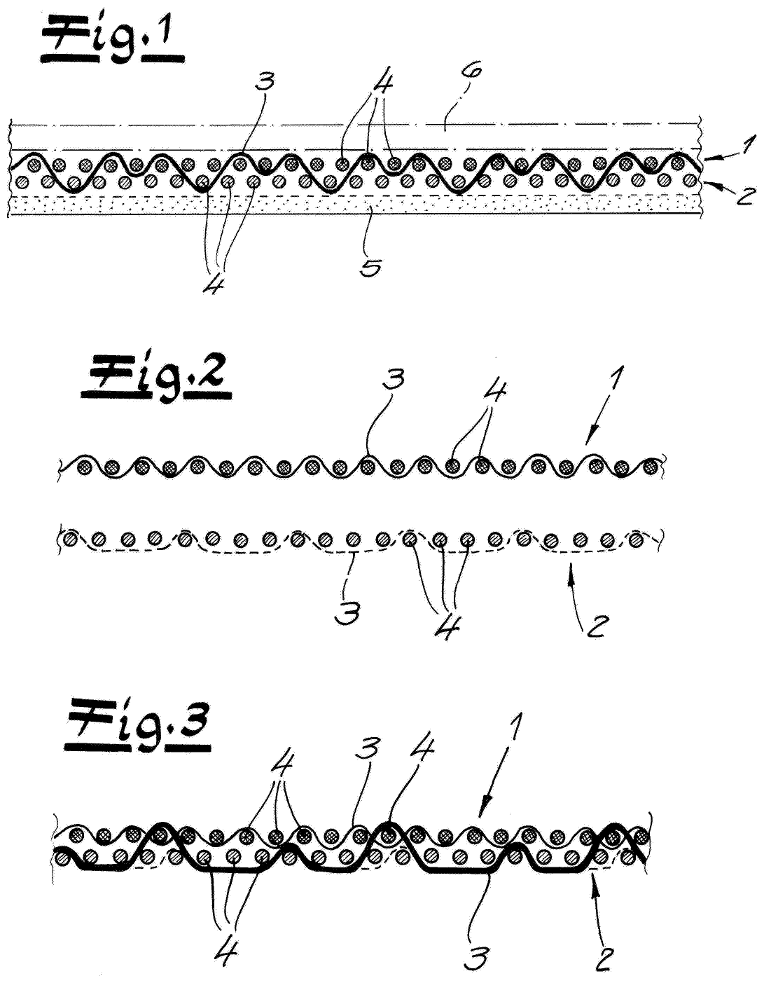

FIG. 1 is a sectional schematic view of the adhesive tape according to the invention,

FIG. 2 shows the two interconnected textile webs of the textile substrate before they are combined and

FIG. 3 shows the substrate according to the invention with the connection filaments for coupling the two textile webs.

The figures show an adhesive tape that is advantageously a tape for wrapping cables in automobiles. In this case, in principle, for the purpose of longitudinal wrapping or tubular wrapping the wrapping tape can be closed in a longitudinal direction around the cable to be wrapped. Alternatively, the adhesive tape that is illustrated and is still to be described in greater detail can also be wound spirally or helically around the cable to be wrapped. This is the usual procedure.

The adhesive tape according to the invention has a textile substrate 1, 2. According to this embodiment and without limitation, the textile substrate is made up of a first textile web 1 and a second textile web 2. Both textile webs 1, 2 or fabric layers according to the invention are mechanically coupled together according to the invention, that is to say by connection filaments 3 of the textile webs. The is indicated in FIG. 1. The connection filaments 3 illustrated there are weft filaments 3 of the first textile web 1 that cross one or more warp filaments 4 of the second textile web 2 as shown. In the sectional view according to FIG. 1 it is possible to see, in each case in section, the warp filaments 4 both of the first textile web 1 and also of the second textile web 2. On the other hand, the associated weft filaments 3 of the textile webs 1, 2 are not explicitly illustrated, and for the sake of clarity only one connection filament or weft filament 3 is shown by way of example.

The textile substrate 1, 2 of the adhesive tape according to the invention is provided with an adhesive coating 5. In fact, the adhesive coating 5 is applied over the entire surface or as a strip coating on the rear face of the second textile web or the second fabric layer 2. In the installed state of the adhesive tape according to the invention the first textile web or the first fabric layer 1 is directed outward. In order to protect this first textile web 1, in principle a coating 6 can also be provided that is indicated by dot-dash lines in FIG. 1. However, such an additional coating 6 is usually unnecessary.

The detailed structure of the substrate 1, 2 is shown clearly with reference to FIGS. 2 and 3. The two textile webs 1, 2 can actually be seen in individual views in FIG. 2. In this case the first textile web 1 is a plain weave. In other words, the individual weft filaments 3 alternately pass over and under the warp filaments 4. On the other hand, the second textile web 2 has a different weave. In fact, in the present case the second textile web 2 is provided with an atlas or satin weave. In this case the weft filaments 3 pass over one warp filament 4 and then under more than two warp filaments 4.

FIG. 3 shows how, the connection filament or weft filament 3 in this case of the second textile web 2 individual warp filaments 4 of the first textile web 1 are crossed and as a result the required mechanical connection is made between the two textile webs 1, 2. In other words, FIG. 3 shows a somewhat modified embodiment by comparison with FIG. 1 in such a way that in this case the connection filament 3 is formed as a weft filament of the second web 2 (with the atlas weave or satin weave) that crosses one or more warp filaments 4 of the first textile web 1. On the other hand, the connection filament 3 according to FIG. 1 is a weft filament of the first textile web 1 that crosses one or more warp filaments 4 of the second textile web 2. Both fundamental configurations are possible.

Thus, the filaments of the textile web 1, 2, that is to say both the warp filaments 4 and also the weft filaments 3, like the connection filaments 3, have an overall fineness of more than 100 dtex. In fact fineness values of 200 dtex and more are usually used. The filaments 3, 4 of the textile web 1, 2 can be formed in each case as polyester filaments. In principle, however, they can also be polyamide filaments. In addition, inorganic filaments 3, 4 such as metal filaments, carbon filaments, glass filaments etc. are also possible. Combinations are also conceivable and are covered by the invention.

1. An adhesive tape for wrapping cables in automobiles, comprising:
a textile substrate having at least one first textile web and a second textile web that are connected together; and
an adhesive coating on at least one face of the substrate; and,
connection filaments of the textile webs interconnecting the first and second textile webs.

2. The adhesive tape according to claim 1, wherein the connection filaments are warp filaments and/or weft filaments of the first textile web.

3. The adhesive tape according to claim 1, wherein the connection filaments are warp filaments and/or weft filaments of the second textile web.

4. The adhesive tape according to claim 1, wherein the two textile webs each have the same weave.

5. The adhesive tape according to claim 1, wherein the two textile webs are of different weaves.

6. The adhesive tape according to claim 1, wherein the connection filaments are weft filaments of the first textile web that cross one or more warp filaments of the second textile web.

7. The adhesive tape according to claim 1, wherein the connection filaments are warp filaments of the first textile web that cross one or more weft filaments of the second textile web.

8. The adhesive tape according to claim 1, wherein the filaments of the first and second textile webs have a fineness of more than 100 dtex and in particular 150 dtex and more.

9. The adhesive tape according to claim 1, wherein the filaments of the first and second textile webs are polyester filaments and/or polyamide filaments and/or inorganic filaments of metal, carbon or glass or combinations thereof.

10. The adhesive tape according to claim 1, wherein the adhesive tape a wrapping tape guided spirally or helically around a cable or a longitudinal wrapping closed around the cable to be wrapped.
